(19) United States
(12) Patent Application Publication
(10) Pub. No.: US 2024/0375688 A1
(43) Pub. Date: Nov. 14, 2024

(54) METHOD FOR IMPROVING THE STABILITY OF CO-OPERATIVE DRIVING MANEUVER PLANNING, AND ELECTRONIC CONTROL DEVICE

(71) Applicant: Continental Automotive Technologies GmbH, Hannover (DE)

(72) Inventors: Sebastian Strunck, Niedernhausen (DE); Thomas Grotendorst, Eschborn (DE)

(73) Assignee: Continental Automotive Technologies GmbH, Hannover (DE)

(21) Appl. No.: 18/692,187

(22) PCT Filed: Sep. 9, 2022
(86) PCT No.: PCT/DE2022/200212

§ 371 Date: Mar. 14, 2024

(30) Foreign Application Priority Data
Sep. 14, 2021 (DE) 10 2021 210 142.9

(51) Int. Cl. B60W 60/00; H04W 4/46

(52) U.S. Cl. CPC B60W 60/0027; B60W 60/0011; H04W 4/46; B60W 2556/65

(57) ABSTRACT

A method for improving the stability of cooperative driving maneuver planning, comprises:
receiving a planned trajectory of a second vehicle by a vehicle-to-X communication device of the first vehicle;
testing the planned trajectory of the second vehicle for absence of contradiction with environmental information of the first vehicle by a test device of the first vehicle, the environmental information of the first vehicle acquired by a sensor of the first vehicle;
executing trajectory planning by a maneuver planning device of the first vehicle and
   using the planned trajectory of the second vehicle for the trajectory planning of the first vehicle when the absence of contradiction is confirmed; and
   not using the planned trajectory of the second vehicle for the trajectory planning of the first vehicle otherwise;
outputting a signal for executing a planned trajectory of the first vehicle.

An electronic control device of the first vehicle carries out the method.

The disclosure relates to a method for improving the stability of cooperative maneuver planning and to a corresponding electronic control device and to the use of the device.

Cooperative driving is based on the fact that vehicles exchange information. In the current discussion, for vehicle-to-X (V2X) communication, this primarily involves dynamic object data based on sensor information and maneuver/trajectory information. If a trajectory or a sequence of maneuvers has been calculated as a result of cooperative coordination, the sensor-based basis of the calculations is usually already comparatively old because the individual delays add up to form a delay chain.

This is intended to be illustrated on the basis of the following example of a delay chain from the perspective of a first vehicle. In this case, a second vehicle creates V2X messages from sensor-based data and from the ego maneuver planning, wherein it is assumed for this purpose that the second vehicle has not initially used any external trajectories in the ego planning. The first vehicle takes the data received with the V2X message as a basis for the ego planning of a maneuver. The numbers are assumed values and are only intended to demonstrate the concatenation:
second vehicle: creation of object data from sensor information: do2=100 ms
second vehicle: fusion of the object data of a plurality of sensors: df2=100 ms
second vehicle: maneuver planning: dm2=100 ms
second vehicle: V2X communication of the result of the maneuver planning: dc2=70 ms
first vehicle: creation of object data from sensor information: do1=100 ms
first vehicle: fusion of the received object data of the first vehicle and the object data of the second vehicle: df1_2=100 ms
first vehicle: maneuver planning: dm1=100 ms

The data are generated with the aid of an environment sensor system for capturing the environment of a vehicle (do) and the data from a plurality of sensors, in particular sensors overlapping in the capture region, are fused (df) and an object list is generated, in the case of which an entry exists in the object list for each real object. The data in the object list can then be transmitted to other vehicles using a cooperative perception message (CPM), in particular using vehicle-to-X communication (dc2). The object list is received by the first vehicle and has to be brought into line with the sensor data from the sensors of the first vehicle, from which the further fusion step (df1_2) results. The maneuver planning then takes place by means of a corresponding computing apparatus in the first vehicle (dm1).

The delay chain, starting from the sensor data ascertained by the second vehicle, for example as a cooperative perception message, up to the planned trajectory in the first vehicle, therefore results as:

$$do 2 + df 2 + dc 2 + df {1}_{-} 2 + dm 1 = 470 ms$$

The delay chain of the external trajectory results as:

$$do 2 + df 2 + dm 2 + dc 2 + dm 1 = 470 ms$$

In this case, delays for example as a result of motor actuation or the actuator system or the driver reaction, etc. have not yet been taken into account.

In this example, the basis for a decision is therefore based on data that are at least approximately 500 ms old. Within this period of time, a vehicle at 50 km/h, which is usually permitted in urban areas, covers a distance of almost 7 m, which can be critical to safety for a pedestrian suddenly entering the road being used.

As soon as the trajectories created by maneuver planning have been calculated and have arrived at the receiver, the sensor data on which the maneuver planning is based and the trajectory resulting therefrom are already outdated on account of the delay chain independently of a coordination process, which goes beyond this, of the communicating road users. In particular, changes in the traffic situation or in the environment that occur within the delay time can lead to a received trajectory possibly no longer being drivable. A maneuver planning that takes these received trajectories into account can be accordingly incorrect and the consequences of this can be safety-critical for road users.

It is an object of the invention to improve the stability of cooperative maneuver planning.

This object is achieved by the subjects of the independent claims. Advantageous configurations can be taken from the subclaims, for example. The content of the claims is incorporated in the content of the description by express reference.

According to a first aspect, a method to be carried out by an electronic control device of a first vehicle, and in particular for improving the stability of cooperative maneuver planning, is described, having the steps of:
receiving a planned trajectory of a second vehicle by means of a vehicle-to-X communication device of the first vehicle;
testing the planned trajectory of the second vehicle for absence of contradiction with environmental information of the first vehicle by means of a test device of the first vehicle, wherein the environmental information of the first vehicle was acquired by means of at least one sensor of the first vehicle;
executing trajectory planning by means of a maneuver planning device of the first vehicle and
   using the planned trajectory of the second vehicle for the trajectory planning of the first vehicle, if the absence of contradiction of the planned trajectory of the second vehicle with the environmental information of the first vehicle is confirmed; or
   not using the planned trajectory of the second vehicle for the trajectory planning of the first vehicle, if the absence of contradiction of the planned trajectory of the second vehicle with the environmental information of the first vehicle is not confirmed;
outputting a signal for executing a planned trajectory of the first vehicle.

An underlying idea is to improve the stability of cooperative maneuver planning by not using a planned trajectory of a second vehicle received by a first vehicle for the maneuver planning of the first vehicle, if the planned trajectory of the second vehicle is subject to latency when processed by the first vehicle to such an extent that there is no absence of contradiction with the current environment situation of the first vehicle.

This prevents a planned trajectory issued by the second vehicle from being used as the basis for a trajectory planning of the first vehicle receiving the planned trajectory of the second vehicle, and based on this, an incorrect trajectory for the first vehicle from being calculated. Thus, a possible miscalculation cycle can be broken. Advantageously, the stability of the driving maneuver planning can be improved by the present invention in particular in the sense that, within the typically short time available for planning the driving maneuvers, a collision-free cooperative driving maneuver can be determined with trajectories to be driven for the first vehicle and the second vehicle. The overall system of vehicles planning a maneuver or the solution of the maneuver planning relating to the cooperatively planning vehicles thus exhibits in particular a convergent and collision-free behavior with regard to the planning of the maneuver. This can increase the road safety of the road users involved, but also of other road users who are only indirectly involved.

A cooperative driving maneuver shall be understood in particular to mean a coordination effected between at least one first vehicle and a second vehicle with exchange of information on the joint planning of collision-free trajectories to be driven for the first vehicle and the second vehicle. A planned trajectory may comprise in particular a planned route to be traveled and/or planned driving dynamics values or planned driving dynamics changes for the planning horizon of the trajectory. For example, the planning horizon can be defined by a length of the route to be traveled and/or a time period.

According to at least one embodiment, the absence of contradiction of the planned trajectory of the second vehicle with the environmental information of the first vehicle is confirmed by the test device if it is ascertained on the basis of the environmental information that the planned trajectory of the second vehicle is collision-free with respect to the first vehicle and/or another road user and/or some other object. With regard to the collision-free nature with respect to the first vehicle and/or the other road user and/or the other object, reference can be made in particular to an expected or planned respective trajectory.

According to at least one embodiment, the absence of contradiction of the planned trajectory of the second vehicle with the environmental information of the first vehicle is confirmed by the test device if a latency of the planned trajectory of the second vehicle does not exceed a limit value. The limit value can be set in particular depending on the current driving situation. This embodiment can be advantageously used in particular if information about the latency of the planned trajectory of the second vehicle can be ascertained.

According to at least one embodiment, the absence of contradiction of the planned trajectory of the second vehicle with the environmental information of the first vehicle is not confirmed by the test device if it is ascertained on the basis of the environmental information that the planned trajectory of the second vehicle is not collision-free with respect to the first vehicle and/or another road user and/or some other object.

According to at least one embodiment, the absence of contradiction of the planned trajectory of the second vehicle with the environmental information of the first vehicle is not confirmed by the test device if a latency of the planned trajectory of the second vehicle exceeds the limit value. Within the time period of the sum of the latencies, for example, the acquisition and fusion of the sensor information by the second vehicle, the creation of the planned trajectory of the second vehicle on the basis of the environmental information obtained using the sensor information, the transmission by means of vehicle-to-X communication to the first vehicle and further processing by the first vehicle, the environmental situation may have changed significantly. Based on the environmental information of the first vehicle, it is detected that the environmental situation has now changed and that the planned trajectory of the second vehicle can no longer be driven collision-free. The term no longer collision-free shall be generally also understood to mean a safety-critical driving situation, in which a required minimum distance, deemed to be safe, would be undershot. This can be specified in particular in a situational and/or application-specific manner.

According to at least one embodiment, the planned trajectory of the second vehicle is discarded if the absence of contradiction of the planned trajectory of the second vehicle with the environmental information of the first vehicle is not confirmed.

By way of example, the trajectory planning can be based on an environment model that is composed of sensor data from the first vehicle and/or external sensor data that have been provided by means of a CPM as already described, for example. The external sensor data can be received, for example, from the second vehicle and/or at least one further road user and/or at least one sensor-assisted intelligent infrastructure system.

According to at least one embodiment, the planned driving trajectory of the second vehicle is comprised by a maneuver coordination message (“MCM”).

According to at least one embodiment, a most probable trajectory (most probable path, MPP) for the second vehicle is calculated by the maneuver planning device and used for the trajectory planning of the first vehicle if the planned trajectory of the second vehicle is not used for the trajectory planning of the first vehicle. The second vehicle is thus treated in particular as a road user who does not have means for V2X communication and cooperative maneuver coordination.

According to at least one embodiment, the basis for the calculation of the most probable trajectory of the second vehicle is formed by a current position and/or a current speed and/or a current course of the second vehicle. This information can be received, for example, independently of the received planned trajectory of the second vehicle by means of V2X communication in particular from the second vehicle, e.g. via a CAM or BSM message according to ETSI or SAE, and/or determined by means of the environmental information.

According to at least one embodiment, the environmental information describes an environmental model of the first vehicle. The environmental information is obtained in particular from a fusion of sensor information from a plurality of sensors of the first vehicle.

According to at least one embodiment, a signal for executing a planned trajectory of the first vehicle is output for reception by a control device for influencing the driving dynamics of the first vehicle.

According to at least one embodiment, the signal for executing a planned trajectory of the first vehicle, which is output by the maneuver planning device, can be a signal for initiating a safety measure to avoid a safety-critical situation, if a potentially safety-critical traffic situation is identified in the testing of the planned trajectory. A safety-critical traffic situation is in particular a risk of a collision or impending collision with the second road user and/or a further road user and/or some other obstacle if the trajectory is executed as planned.

According to at least one embodiment, the planned trajectory of the first vehicle may involve an evasive maneuver and/or an emergency braking and/or a minimum risk maneuver (“MRM”), in particular if it requires a safety measure to be initiated to avoid a safety-critical situation. The signal for initiating a safety measure is in particular output by means of a signal interface to a corresponding vehicle device for executing the safety measure.

According to one development, the planned trajectory of the second vehicle may be a planned trajectory that has already been cooperatively coordinated between the first vehicle and the second vehicle, wherein the trajectory takes into account or comprises in particular information of a driving maneuver planned between the first vehicle and the second vehicle, in particular also a planned trajectory of the first vehicle. By way of example, in this context, a trajectory can therefore also define interventions in the driving dynamics, for example at a defined point or after a planned distance traveled. It is therefore possible that steps for cooperative maneuver planning between the first vehicle and the second vehicle in order to determine the planned trajectory have already taken place in advance. A cooperative exchange of, for example, object information and/or information relating to the trajectories is effected in particular by means of vehicle-to-X communication.

A vehicle may be a motor vehicle, in particular a passenger motor vehicle, a heavy goods vehicle, a motorcycle, an electric motor vehicle or a hybrid motor vehicle, a watercraft or an aircraft.

According to a second aspect, an electronic control device for a first vehicle is described, comprising:
a vehicle-to-X communication device for receiving a planned trajectory of a second vehicle;
a test device, configured to perform a test of the planned trajectory of the second vehicle for absence of contradiction with environmental information of the first vehicle, wherein the environmental information of the first vehicle was acquired by means of at least one sensor of the first vehicle;
a maneuver planning device, configured to use the planned trajectory of the second vehicle for the trajectory planning of the first vehicle if the absence of contradiction of the planned trajectory of the second vehicle with the environmental information of the first vehicle is confirmed, or not to use the planned trajectory of the second vehicle for the trajectory planning of the first vehicle if the absence of contradiction of the planned trajectory of the second vehicle with the environmental information of the first vehicle is not confirmed, the maneuver planning device being further configured to output a signal for executing a planned trajectory of the first vehicle.

According to a further aspect, the device is designed to carry out a method as claimed in at least one of the preceding described embodiments.

In one development of the specified device, the specified device has a memory and a processor. In this case, the specified method is stored in the memory in the form of a computer program, and the processor is provided for carrying out the method when the computer program is loaded into the processor from the memory.

According to a further aspect of the invention, a computer program comprises program code means in order to perform all the steps of one of the specified methods when the computer program is executed on a computer or one of the specified devices.

According to a further aspect of the invention, a computer program product contains a program code that is stored on a computer-readable data carrier and that, when executed on a data processing apparatus, carries out one of the specified methods.

Some particularly advantageous configurations of the invention are specified in the dependent claims. Further preferred embodiments also emerge from the following description of exemplary embodiments on the basis of figures.

In each case, schematically:

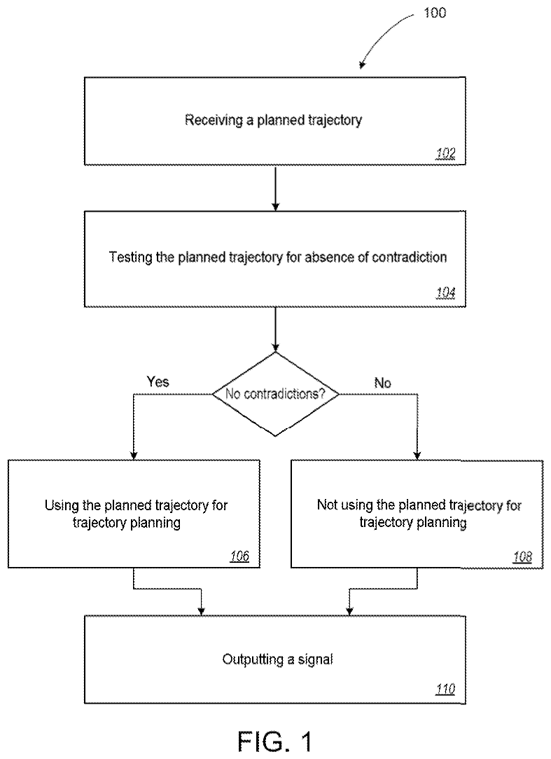

FIG. 1 shows a flow diagram of an embodiment of the method to be carried out by an electronic control device of a first vehicle, and in particular for improving the stability of cooperative maneuver planning, and

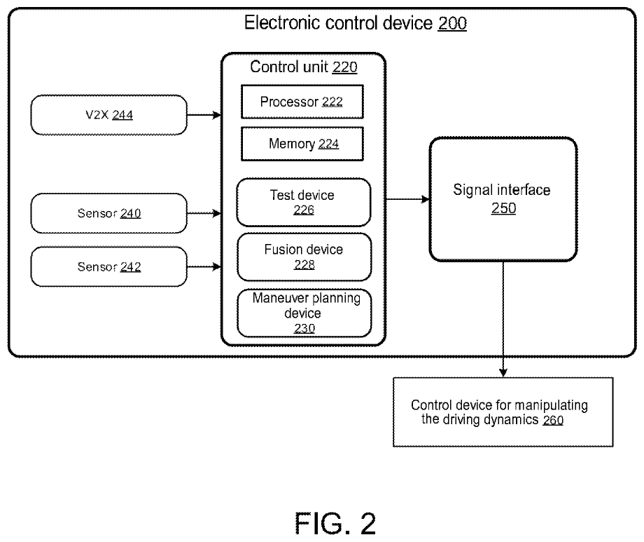

FIG. 2 shows an embodiment of the electronic control device.

FIG. 1 shows an embodiment of the method 100 to be carried out by an electronic control device of a first vehicle. In a step 102 a planned trajectory of a second vehicle is received by means of a vehicle-to-X communication device of the first vehicle.

In a step 104 the planned trajectory of the second vehicle is tested for absence of contradiction with environmental information of the first vehicle by means of a test device of the first vehicle, wherein the environmental information of the first vehicle was acquired by means of at least one sensor of the first vehicle.

If an absence of contradiction is determined in step 104, in step 106 a trajectory planning is executed by a maneuver planning device of the first vehicle and the planned trajectory of the second vehicle is used for the trajectory planning of the first vehicle.

If no absence of contradiction is determined in step 104, in step 108 a trajectory planning is executed by the maneuver planning device of the first vehicle, in which case the planned trajectory of the second vehicle is not used for the trajectory planning of the first vehicle. According to at least one embodiment, the planned trajectory of the second vehicle is discarded if the absence of contradiction of the planned trajectory of the second vehicle with the environmental information of the first vehicle is not confirmed.

In step 110 a signal is output for executing a planned trajectory of the first vehicle.

FIG. 2 shows an embodiment of the electronic control device 200 for a first vehicle. The vehicle is not depicted in FIG. 2.

The control device 200 comprises a vehicle-to-X communication device 244 for receiving a planned trajectory of a second vehicle, and a test device 226, which is configured to perform a test of the received planned trajectory of the second vehicle for absence of contradiction with environmental information of the first vehicle, wherein the environmental information of the first vehicle was acquired by means of at least one sensor 240, 242 of the first vehicle.

The electronic control device also comprises a maneuver planning device 230, which is configured to use the planned trajectory of the second vehicle for the trajectory planning of the first vehicle if the absence of contradiction of the planned trajectory of the second vehicle with the environmental information of the first vehicle is confirmed, and not to use the planned trajectory of the second vehicle for the trajectory planning of the first vehicle if the absence of contradiction of the planned trajectory of the second vehicle with the environmental information of the first vehicle is not confirmed. The maneuver planning device 230 is further configured to output a signal for executing a planned trajectory of the first vehicle, for example, by means of a signal interface 250. The output is effected according to this exemplary embodiment to a control device 260 for influencing the driving dynamics of the first vehicle.

According to the embodiment shown in FIG. 2, the test device 226 and the maneuver planning device 230 are comprised by a control unit 220. The control unit 220 may further comprise a processor 222, a memory 224 and/or a fusion device 228. According to at least one embodiment, the environmental information describes an environmental model of the first vehicle. The environmental information can be obtained in particular from a fusion of sensor information from a plurality of sensors 240, 242 of the first vehicle.

According to a further aspect, the electronic control device 200 is configured in particular to carry out a method as claimed in at least one of the described embodiments.

If it is found in the course of the proceedings that a feature or a group of features is not absolutely necessary, then the applicant aspires right now to a wording of at least one independent claim that no longer has the feature or the group of features. This may be, for example, a subcombination of a claim present on the filing date or a subcombination of a claim present on the filing date that is restricted by further features. Claims or combinations of features of this kind requiring rewording are intended to be understood as also covered by the disclosure of this application.

It should also be pointed out that refinements, features and variants of the invention which are described in the various embodiments or exemplary embodiments and/or shown in the figures may be combined with one another in any desired manner. Single or multiple features are interchangeable with one another in any desired manner. Combinations of features arising therefrom are intended to be understood as also covered by the disclosure of this application.

Back-references in dependent claims are not intended to be understood as a relinquishment of the attainment of independent substantive protection for the features of the back-referenced dependent claims. These features may also be combined with other features in any desired manner.

Features that are only disclosed in the description or features that are only disclosed in the description or in a claim in conjunction with other features may in principle be of independent significance essential to the invention. They may therefore also be individually included in claims for the purpose of delimitation from the prior art.

In general, it should be pointed out that vehicle-to-X communication is understood to mean, in particular, a direct communication between vehicles and/or between vehicles and infrastructure apparatuses. For example, it may therefore include vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication may be implemented using the IEEE 802.11p or IEEE 1609.4 or 5G PC5/Sidelink standards. A vehicle-to-X communication may also be referred to as C2X communication or V2X communication. The sub-domains may be referred to as C2C (car-to-car), V2V (vehicle-to-vehicle) or C2I (car-to-infrastructure), V2I (vehicle-to-infrastructure). However, the invention does not explicitly exclude vehicle-to-X communication with switching via a mobile radio network, for example.

1. A method to be carried out by an electronic control device of a first vehicle, the method comprising:
receiving a planned trajectory of a second vehicle by a vehicle-to-X communication device of the first vehicle;
testing the planned trajectory of the second vehicle for absence of contradiction with environmental information of the first vehicle by a test device of the first vehicle, wherein the environmental information of the first vehicle was acquired by at least one sensor of the first vehicle;
executing trajectory planning by a maneuver planning device of the first vehicle; and
using the planned trajectory of the second vehicle for the trajectory planning of the first vehicle when the absence of contradiction of the planned trajectory of the second vehicle with the environmental information of the first vehicle is confirmed; or
not using the planned trajectory of the second vehicle for the trajectory planning of the first vehicle when the absence of contradiction of the planned trajectory of the second vehicle with the environmental information of the first vehicle is not confirmed; and
outputting a signal for executing a planned trajectory of the first vehicle.

2. The method as claimed in claim 1, wherein a most probable trajectory for the second vehicle is calculated by the maneuver planning device and used for the trajectory planning of the first vehicle when the planned trajectory of the second vehicle is not used for the trajectory planning of the first vehicle.

3. The method as claimed in claim 2, wherein for the calculation of at least one of the most probable trajectory of the second vehicle, a current position, a current speed and a current course of the second vehicle is determined using information at least one of received by vehicle-to-X communication and based on the environmental information of the first vehicle.

4. The method as claimed in claim 1, wherein the absence of contradiction of the planned trajectory of the second vehicle with the environmental information of the first vehicle is confirmed by the test device when it is ascertained based on the environmental information that the planned trajectory of the second vehicle is collision-free with respect to at least one of the first vehicle, another road user and some other object.

5. The method as claimed in claim 1, wherein the absence of contradiction of the planned trajectory of the second vehicle with the environmental information of the first vehicle is confirmed by the test device when a latency of the planned trajectory of the second vehicle does not exceed a limit value.

6. The method as claimed in claim 1, wherein the absence of contradiction of the planned trajectory of the second vehicle with the environmental information of the first vehicle is not confirmed by the test device when it is ascertained based on the environmental information that the planned trajectory of the second vehicle is not collision-free with respect to at least one of the first vehicle, another road user and/or some other object.

7. The method as claimed in claim 1, wherein the absence of contradiction of the planned trajectory of the second vehicle with the environmental information of the first vehicle is not confirmed by the test device when a latency of the planned trajectory of the second vehicle exceeds the limit value.

8. An electronic control device for a first vehicle, comprising:
a vehicle-to-X communication device configured to receive a planned trajectory of a second vehicle;
a test device, configured to perform a test of the planned trajectory of the second vehicle for absence of contradiction with environmental information of the first vehicle, wherein the environmental information of the first vehicle was acquired by at least one sensor of the first vehicle;
a maneuver planning device, configured to use the planned trajectory of the second vehicle for the trajectory planning of the first vehicle when the absence of contradiction of the planned trajectory of the second vehicle with the environmental information of the first vehicle is confirmed, or not to use the planned trajectory of the second vehicle in the trajectory planning of the first vehicle when the absence of contradiction of the planned trajectory of the second vehicle with the environmental information of the first vehicle is not confirmed, the maneuver planning device being further configured to output a signal for executing a planned trajectory of the first vehicle.

9. The electronic control device as claimed in claim 8, configured to:
receive a planned trajectory of a second vehicle by a vehicle-to-X communication device of the first vehicle;
test the planned trajectory of the second vehicle for absence of contradiction with environmental information of the first vehicle by a test device of the first vehicle, wherein the environmental information of the first vehicle was acquired by at least one sensor of the first vehicle;
execute trajectory planning by a maneuver planning device of the first vehicle and
using the planned trajectory of the second vehicle for the trajectory planning of the first vehicle when the absence of contradiction of the planned trajectory of the second vehicle with the environmental information of the first vehicle is confirmed: or
not use the planned trajectory of the second vehicle for the trajectory planning of the first vehicle when the absence of contradiction of the planned trajectory of the second vehicle with the environmental information of the first vehicle is not confirmed;
output a signal for executing a planned trajectory of the first vehicle.

10. Use of the device claimed in claim 8.

11. The electronic control device as claimed in claim 9, wherein a most probable trajectory for the second vehicle is calculated by the maneuver planning device and used for the trajectory planning of the first vehicle when the planned trajectory of the second vehicle is not used for the trajectory planning of the first vehicle.

12. The electronic control device as claimed in claim 11, wherein for the calculation of at least one of the most probable trajectory of the second vehicle, a current position, a current speed and a current course of the second vehicle is determined using information at least one of received by vehicle-to-X communication and based on the environmental information of the first vehicle.

13. The electronic control device as claimed in claim 9, wherein the absence of contradiction of the planned trajectory of the second vehicle with the environmental information of the first vehicle is confirmed by the test device when it is ascertained based on the environmental information that the planned trajectory of the second vehicle is collision-free with respect to at least one of the first vehicle, another road user and some other object.

14. The electronic control device as claimed in claim 9, wherein the absence of contradiction of the planned trajectory of the second vehicle with the environmental information of the first vehicle is confirmed by the test device when a latency of the planned trajectory of the second vehicle does not exceed a limit value.

15. The electronic control device as claimed in claim 9, wherein the absence of contradiction of the planned trajectory of the second vehicle with the environmental information of the first vehicle is not confirmed by the test device when it is ascertained based on the environmental information that the planned trajectory of the second vehicle is not collision-free with respect to at least one of the first vehicle, another road user and some other object.

16. The electronic control device as claimed in claim 9, wherein the absence of contradiction of the planned trajectory of the second vehicle with the environmental information of the first vehicle is not confirmed by the test device when a latency of the planned trajectory of the second vehicle exceeds the limit value.

17. Use of the device claimed in claim 9.
